(19) United States
(12) Patent Application Publication
(10) Pub. No.: US 2020/0187334 A1
(43) Pub. Date: Jun. 11, 2020

(54) SYSTEMS AND METHODS FOR GENERATING A LIGHTING DESIGN

(71) Applicant: Electronic Theatre Controls, Inc., Middleton, WI (US)

(72) Inventors: Al Crawford, Middleton, WI (US); Christopher Mizerak, Oceanside, CA (US); Koen Buys, Hofstade (BE); Dennis Varian, Middleton, WI (US)

(21) Appl. No.: 16/708,781

(22) Filed: Dec. 10, 2019

Related U.S. Application Data
(60) Provisional application No. 62/777,469, filed on Dec. 10, 2018.
(60) Provisional application No. 62/777,466, filed on Dec. 10, 2018.

(51) Int. Cl. H05B 47/155; G06F 3/0484; G06F 3/0481; H05B 47/16; H05B 47/125; H05B 47/175

(52) U.S. Cl. CPC H05B 47/155; G06F 3/04847; H05B 47/175; H05B 47/16; H05B 47/125; G06F 3/04815

(57) ABSTRACT

Systems and methods for generating a lighting design for a venue. The system includes a display device and a controller including an electronic processor connected to a memory. The memory stores instructions that when executed by the electronic processor configure the controller to receive object data based on a detected object in the venue, display the object data as a representation of the detected object in an interactive lighting environment, receive a user input via the interactive lighting environment to change lighting data that controls virtual lighting represented in the interactive lighting environment, and alter the virtual lighting represented in the interactive lighting environment based on the user input.

### CROSS-REFERENCE TO RELATED APPLICATIONS

This application claims the benefit of U.S. Provisional Patent Application No. 62/777,469, filed on Dec. 10, 2018, and U.S. Provisional Patent Application No. 62/777,466, filed on Dec. 10, 2018, the entire contents of both of which are hereby incorporated by references.

### FIELD

Embodiments described herein relate to preparing a lighting design for a performance.

### SUMMARY

Designing, updating, testing, and calibrating lighting visuals are important parts of preparing the lighting fixtures at a venue for an upcoming event. The lighting visuals can be of varying composition types including, but not limited to, static or dynamic combinations of lighting elements. Lighting visuals include, for example, moving lighting transitions, follow spots, and other dynamic lighting visuals (e.g., fading and other transitions). Lighting visuals can also include static background lighting (e.g., color, intensity, saturation, etc.). Because the event for which the lighting visuals are being prepared has a deadline, the time to design and set up the lighting visuals is limited.

Some of the most important information about an upcoming show is where the performers, moving scenery elements, or other objects will be on the stage throughout the show. This information tells a user where to direct the lighting visuals throughout the show. Other important information, such as the body language of a performer and the duration of time a performer remains at a certain mark on the stage, can also be helpful in determining the brightness, color, mood, shape, focus, and other features of the lighting visuals to be used.

Ideally, the user would be able to have the performers conduct as many rehearsals as necessary for lighting design purposes. Rehearsals are limited, however, because of the time constraints, costs, and need for live performers. Often, only a few rehearsals are performed at a venue prior to an event. Perhaps only one of those rehearsals, if any, is a full dress rehearsal. This limited insight into the dynamics and appearance of the performers and moving objects can inhibit the creation and improvement of desired lighting visuals. Further, last-minute changes to the lighting visuals typically have to be improvised at the event if a last-minute rehearsal is not possible.

Additionally, many events require hundreds of lighting fixtures and dozens of distinct lighting visuals. The time required to get the lighting fixtures ready for each particular lighting visual makes it difficult to time the preparation of the lighting visuals such that they can be tested during a dress rehearsal. In some of the most difficult situations, a user may only receive movement information in the form of one or more marks made with tape on the surface of a stage to indicate performer locations. Lighting designers can only guess as to how the desired lighting visuals will look paired with an actual performer's clothes and movements prior to the event, especially if the lighting visuals cannot be tested during a dress rehearsal. This uncertainty prevents lighting designers from experimenting with new lighting visuals, and causes them to fall back on known techniques and safe choices.

To address these concerns, embodiments described herein provide systems and methods for capturing a stage performance and displaying the performance in an interactive environment. These systems and methods could provide a user with unlimited opportunities to view the stage performance and update the lighting visuals accordingly. These systems and methods could also reduce the setup time required to prepare the lighting visuals at a venue because the initial captured performance need not be repeated and need not have originally been performed at the venue. Also, updates to the lighting visuals can be made and tested with the captured performance, which reduces guesswork and inaccuracies if another rehearsal is not scheduled.

Methods described herein provide for generating a lighting design for a venue. The methods include receiving, with an electronic processor, object data based on a detected object in the venue, displaying, using the electronic controller, the object data as a representation of the detected object in an interactive lighting environment, receiving, with the controller, a user input via the interactive lighting environment to change lighting data that controls virtual lighting represented in the interactive lighting environment, and altering, using the electronic controller, the virtual lighting represented in the interactive lighting environment based on the user input.

In some embodiments, the altering of the virtual lighting represented in the interactive lighting environment based on the user input includes changing the brightness of the lighting, changing the color of the lighting, changing the shape of the lighting, changing projected images, changing projected video, changing special effects, changing a strobe, and/or changing a position, direction, or movement of a light beam in the interactive lighting environment.

In some embodiments, the methods further include storing in a memory, using the electronic controller, a command string based on the user input received via the interactive lighting environment to change lighting data.

In some embodiments, the command string includes timing data for at least one lighting fixture at the venue.

In some embodiments, the methods further include controlling at least one lighting fixture at the venue based on the command string.

In some embodiments, the interactive lighting environment is superimposed on a video of the venue or live images of the venue (e.g., augmented reality).

In some embodiments, the methods further include detecting the object with at least one camera.

In some embodiments, the representation of the detected object in the interactive lighting environment is a three-dimensional representation of the object.

In some embodiments, the object data is based on a position of the detected object relative to a reference point at the venue.

In some embodiments, the methods further include detecting the position of the object using a sensor.

Systems described herein provide for generating a lighting design for a venue. The system includes a display device and a controller including an electronic processor connected to a memory. The memory stores instructions that when executed by the electronic processor configure the controller to receive object data based on a detected object in the venue, display the object data as a representation of the detected object in an interactive lighting environment, receive a user input via the interactive lighting environment to change lighting data that controls virtual lighting represented in the interactive lighting environment, and alter the virtual lighting represented in the interactive lighting environment based on the user input.

In some embodiments, the virtual lighting represented in the interactive lighting environment is altered to change the brightness of the lighting, change the color of the lighting, change the shape of the lighting, change projected images, change projected video, change special effects, change a strobe, and/or change a position, direction, or movement of a light beam in the interactive lighting environment.

In some embodiments, the controller is further configured to store, in the memory, a command string based on the user input received via the interactive lighting environment to change lighting data.

In some embodiments, the command string includes timing data for at least one lighting fixture at the venue.

In some embodiments, the controller is further configured to control at least one lighting fixture at the venue based on the command string.

In some embodiments, the interactive lighting environment is superimposed on a video of the venue or live images of the venue relative to a reference point at the stage or venue (e.g., augmented reality).

In some embodiments, the systems further include at least one camera, and the object is detected with the at least one camera.

In some embodiments, the representation of the detected object in the interactive lighting environment is a three-dimensional representation of the object.

In some embodiments, the object data is based on a position of the detected object relative to a reference point at the venue.

In some embodiments, the systems further include a sensor configured to detect the position of the object.

Before any embodiments are explained in detail, it is to be understood that the embodiments are not limited in its application to the details of the configuration and arrangement of components set forth in the following description or illustrated in the accompanying drawings.

The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Other aspects of the embodiments will become apparent by consideration of the detailed description and accompanying drawings.

### BRIEF DESCRIPTION OF THE DRAWINGS

FIG. 1 illustrates a system for generating a lighting design for a venue.

FIG. 1A illustrates an alternative system for generating a lighting design for a venue.

FIG. 2 illustrates a controller for the system of FIG. 1.

FIG. 2A illustrates a controller for the system of FIG. 1A.

FIG. 3 illustrates a control board, a camera, and a lighting fixture in a venue during a rehearsal for the system of FIG. 1.

FIG. 3A illustrates a camera and a lighting fixture in a venue during a rehearsal for the system of FIG. 1A.

FIG. 4 illustrates a captured image of the rehearsal with moving objects and performers digitized into wire frame elements.

FIG. 5 illustrates an example application screen displaying virtualized bodies, virtual lighting fixtures, and virtual light beams shown within an interactive environment.

FIG. 6 illustrates a flowchart of a method of generating a lighting design for a venue.

FIG. 7 illustrates a flowchart of another method of generating a lighting design for a venue.

FIG. 8 illustrates cameras and lighting fixtures in a venue for the system of FIG. 1.

FIG. 8A illustrates cameras and lighting fixtures in a venue for the system of FIG.

1A.

FIG. 9 illustrates an example of an application interface screen for use with the system of FIG. 1 and/or FIG. 1A that controls the movement of the lighting fixture according to a user input

FIG. 10 illustrates an example of the scan of the surface the camera may observe to determine the centroid of a lighting beam.

FIG. 11 illustrates an example of an application interface screen for use with the system of FIG. 1 and/or FIG. 1A that controls the movement of the lighting fixture according to a user input designating the lighting beam destination.

FIG. 12 illustrates a flowchart of an example method of determining a lighting fixture arrangement.

FIG. 13 illustrates a flowchart of another example method of determining a lighting fixture arrangement.

FIG. 14 illustrates a flowchart of an example method of directing a lighting fixture in a venue.

### DETAILED DESCRIPTION

Providing lighting designers, lighting console operators, lighting system technicians, or the like with adequate information as to where the performers, moving scenery elements, or other objects will be on the stage throughout a show, the body language of the performers, and other aesthetic features of the performers typically requires at least one dress rehearsal. Completing the lighting design for the lighting visuals in time to test them during a rehearsal is very difficult, and any changes between rehearsals or after the final rehearsal are prone to mistakes and inaccuracies. Systems and methods described herein provide an interactive environment for testing lighting visuals of a lighting design on a previously captured performance. These systems and methods address the technical problems associated with designing, calibrating, and updating lighting visuals in a lighting design. The lighting visuals can be of varying composition types including, but not limited to, static or dynamic combinations of lighting elements. Lighting visuals include, for example, moving lighting transitions, follow spots, and other dynamic lighting visuals (e.g., fading and other transitions). Lighting visuals can also include static background lighting (e.g., color, intensity, saturation, fading, etc.).

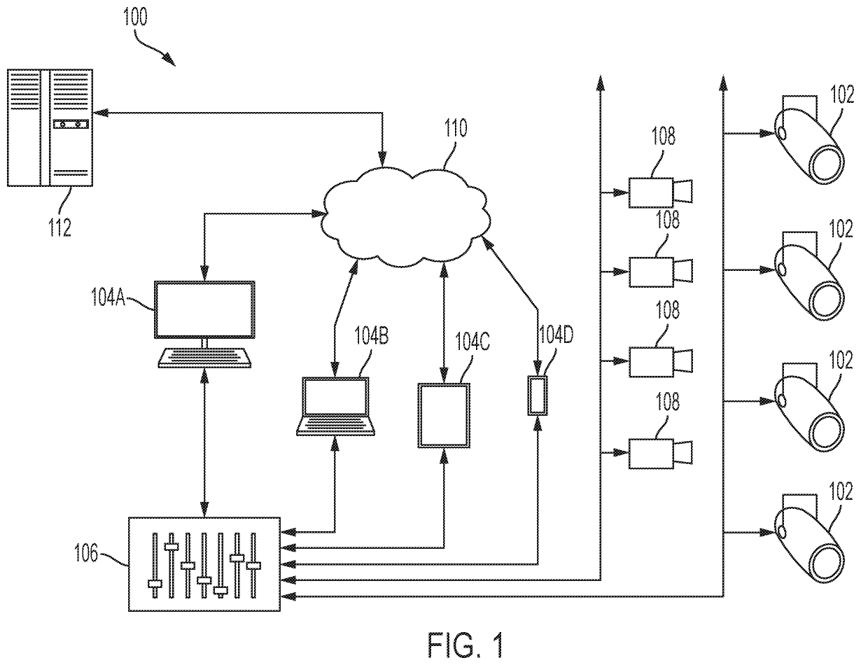

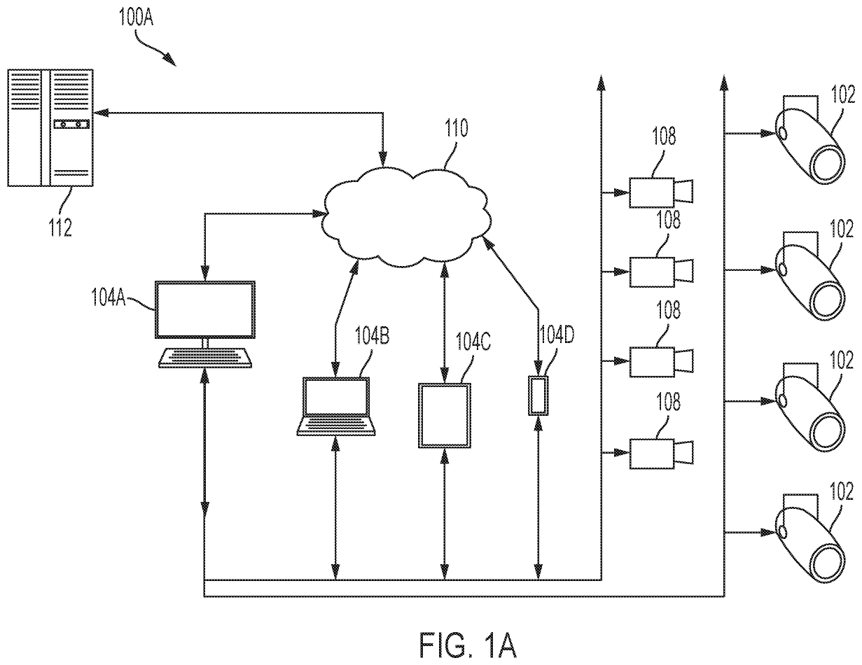

FIG. 1 illustrates a system 100 for generating a lighting design for an event or venue and subsequently controlling one or more lighting fixtures 102. The system 100 includes a user input device 104A-104D, a control board or control panel 106, lighting fixtures 102, cameras 108, a network 110, and a server-side computer or server 112. The user input device 104A-104D includes, for example, a personal or desktop computer 104A, a laptop computer 104B, a tablet computer 104C, or a mobile phone (e.g., a smart phone) 104D. Other user input devices 104A-104D may include, for example, an augmented reality headset or glasses. In some embodiments, the cameras 108 are integrated with the user input device 104A-104D, such as the camera of the mobile phone 104D. In other embodiments, the cameras 108 are entirely separate from the user input device 104A-104D. Example cameras 108 include, for instance, stereo cameras for gathering data including depth, infrared cameras for gathering data in low-light conditions, scanners detecting a laser in a Light Detection and Ranging (“LIDAR”) operation, motion capture tools (such as those produced by Vicon Motion Systems), projected structured light cameras, or the like.

The user input device 104A-104D is configured to communicatively connect to the server 112 through the network 110 and provide information to, or receive information from, the server 112 related to the control or operation of the system 100. The user input device 104A- 104D is also configured to communicatively connect to the control board 106 to provide information to, or receive information from, the control board 106. The connections between the user input device 104A-104D and the control board 106 or network 110 are, for example, wired connections, wireless connections, or a combination of wireless and wired connections. Similarly, the connections between the server 112 and the network 110, the control board 106 and the lighting fixtures 102, or the control board 106 and the cameras 108 are wired connections, wireless connections, or a combination of wireless and wired connections.

The network 110 is, for example, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In some implementations, the network 110 is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4 GSM network, a 4G LTE network, a 5G New Radio, a Digital Enhanced Cordless Telecommunications (“DECT”) network, a Digital AMPS (“IS-136/TDMA”) network, or an Integrated Digital Enhanced Network (“iDEN”) network, etc.

FIG. 1A illustrates an alternative system 100A for generating a lighting design for an event or venue and subsequently controlling a lighting fixture 102. The hardware of the alternative system 100A is identical to the above system 100, except the control board or control panel 106 is removed. As such, the user input device 104A-104D is configured to communicatively connect to the lighting fixture 102 and to the cameras 108. The connections between the user input device 104A-104D and the lighting fixture 102 and the connections between the user input device 104A-104D and the cameras 108 are wired connections, wireless connections, or a combination of wireless and wired connections.

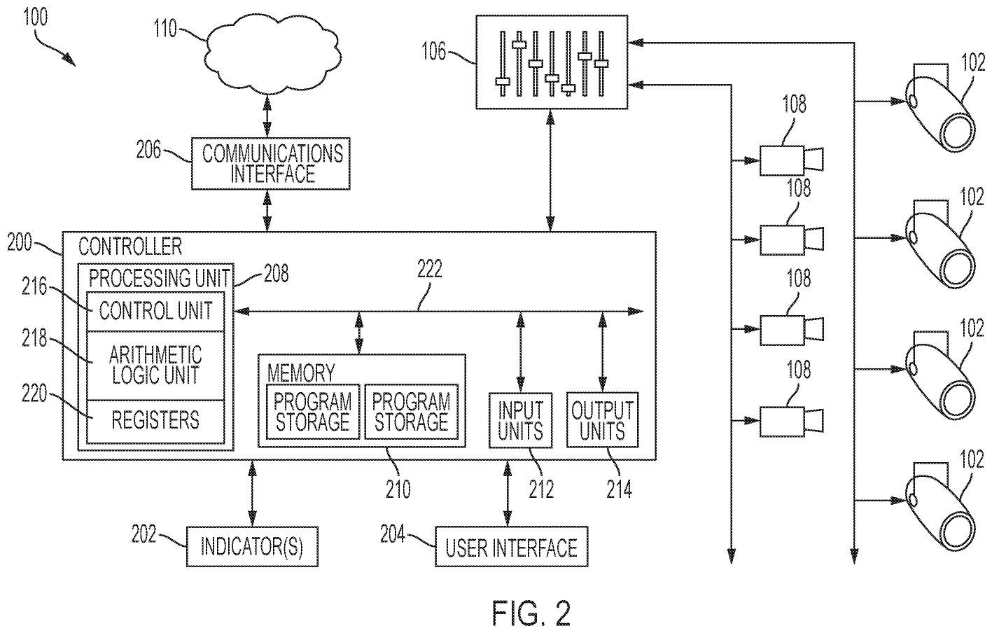

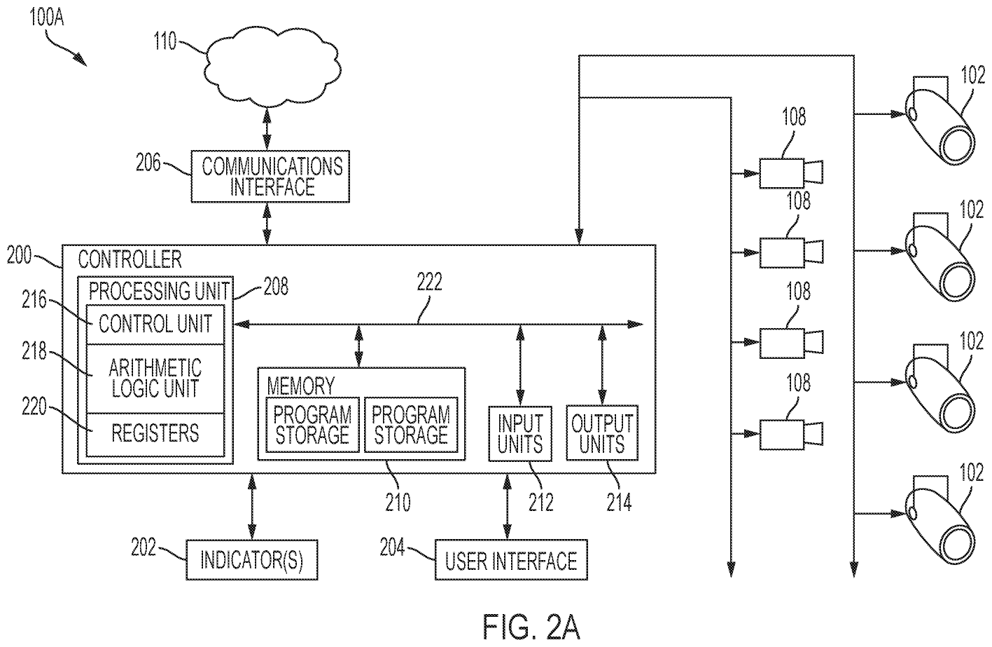

FIG. 2 illustrates a controller 200 for the system 100. The controller 200 is electrically and/or communicatively connected to a variety of modules or components of the system 100. For example, the illustrated controller 200 is connected to one or more indicators 202 (e.g., LEDs, a liquid crystal display [“LCD”], etc.), a user input or user interface 204 (e.g., a user interface of the user input device 104A-104D in FIG. 1), and a communications interface 206. The controller 200 is also connected to the control board 106. The communications interface 206 is connected to the network 110 to enable the controller 200 to communicate with the server 112. The controller 200 includes combinations of hardware and software that are operable to, among other things, control the operation of the system 100, control the operation of the lighting fixture 102, control the operation of the cameras 108, receive one or more signals from the camera 108s, communicate over the network 110, communicate with the control board 106, receive input from a user via the user interface 204, provide information to a user via the indicators 202, etc. In some embodiments, the indicators 202 and the user interface 204 may be integrated together in the form of, for instance, a touch-screen.

In the embodiment illustrated in FIG. 2, the controller 200 is associated with the user input device 104A-104D. As a result, the controller 200 is illustrated in FIG. 2 as being connected to the control board 106 which is, in turn, connected to the lighting fixtures 102 and the cameras 108. In other embodiments, the controller 200 is included within the control board 106, and, for example, the controller 200 can provide control signals directly to the lighting fixtures 102 and the cameras 108. In other embodiments, the controller 200 is associated with the server 112 and communicates through the network 110 to provide control signals to the control board 106, the lighting fixtures 102, and the cameras 108.

The controller 200 includes a plurality of electrical and electronic components that provide power, operational control, and protection to the components and modules within the controller 200 and/or the system 100. For example, the controller 200 includes, among other things, a processing unit 208 (e.g., an electronic processor, a microprocessor, a microcontroller, or another suitable programmable device), a memory 210, input units 212, and output units 214. The processing unit 208 includes, among other things, a control unit 216, an arithmetic logic unit (“ALU”) 218, and a plurality of registers 220 (shown as a group of registers in FIG. 2), and is implemented using a known computer architecture (e.g., a modified Harvard architecture, a von Neumann architecture, etc.). The processing unit 208, the memory 210, the input units 212, and the output units 214, as well as the various modules or circuits connected to the controller 200 are connected by one or more control and/or data buses (e.g., common bus 222). The control and/or data buses are shown generally in FIG. 2 for illustrative purposes. The use of one or more control and/or data buses for the interconnection between and communication among the various modules, circuits, and components would be known to a person skilled in the art in view of the embodiments described herein.

The memory 210 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 208 is connected to the memory 210 and executes software instructions that are capable of being stored in a RAM of the memory 210 (e.g., during execution), a ROM of the memory 210 (e.g., on a generally permanent basis), or another non-transitory computer readable medium such as another memory or a disc. Software included in the implementation of the system 100 and controller 200 can be stored in the memory 210 of the controller 200. The software includes, for example, firmware, one or more applications, program data, filters, rules, one or more program modules, and other executable instructions. The controller 200 is configured to retrieve from the memory 210 and execute, among other things, instructions related to the control processes and methods described herein. In other embodiments, the controller 200 includes additional, fewer, or different components.

The user interface 204 is included to provide user control of the system 100, the lighting fixture 102, and/or the camera 108. The user interface 204 is operably coupled to the controller 200 to control, for example, drive signals provided to the lighting fixture 102 and/or drive signals provided to the cameras 108. The user interface 204 can include any combination of digital and analog input devices required to achieve a desired level of control for the system 100. For example, the user interface 204 can include a computer having a display and input devices, a touch-screen display, a plurality of knobs, dials, switches, buttons, faders, or the like. In the embodiment illustrated in FIG. 2, the user interface 204 is separate from the control board 106. In other embodiments, the user interface 204 is included in the control board 106.

The controller 200 is configured to work in combination with the control board 106 to provide direct control or drive signals to the lighting fixtures 102 and/or the cameras 108. As described above, in some embodiments, the controller 200 is configured to provide direct drive signals to the lighting fixtures 102 and/or the cameras 108 without separately interacting with the control board 106 (e.g., the control board 106 includes the controller 200). The direct drive signals that are provided to the lighting fixtures 102 and/or the cameras 108 are provided, for example, based on a user input received by the controller 200 from the user interface 204. The controller 200 is also configured to receive one or more signals from the cameras 108 related to image or scan data.

As shown in FIG. 2A and described above, the system 100A includes the controller 200 configured to work without the control board 106, such that the controller 200 is configured to provide signals to the lighting fixtures 102 and/or the cameras 108 and to receive one or more signals from the cameras 108 related to image or scan data.

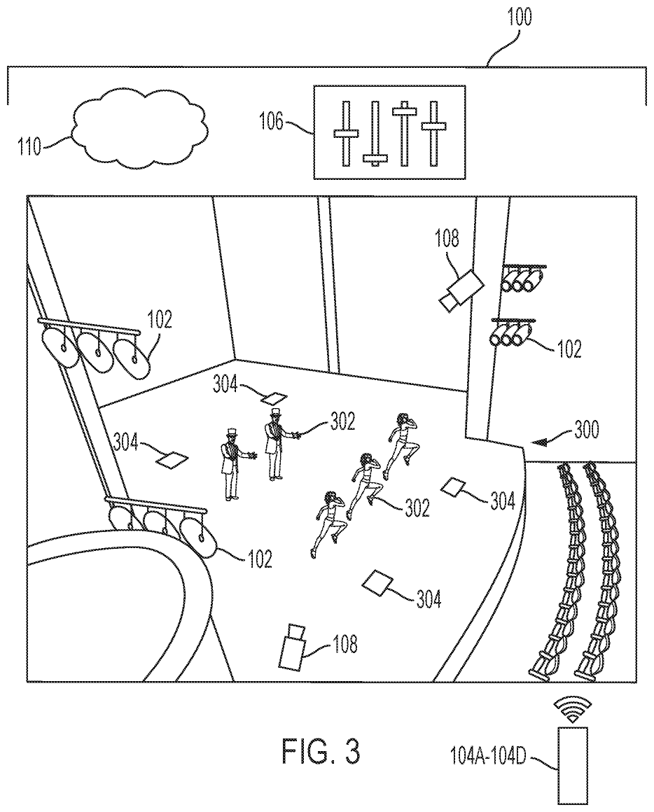

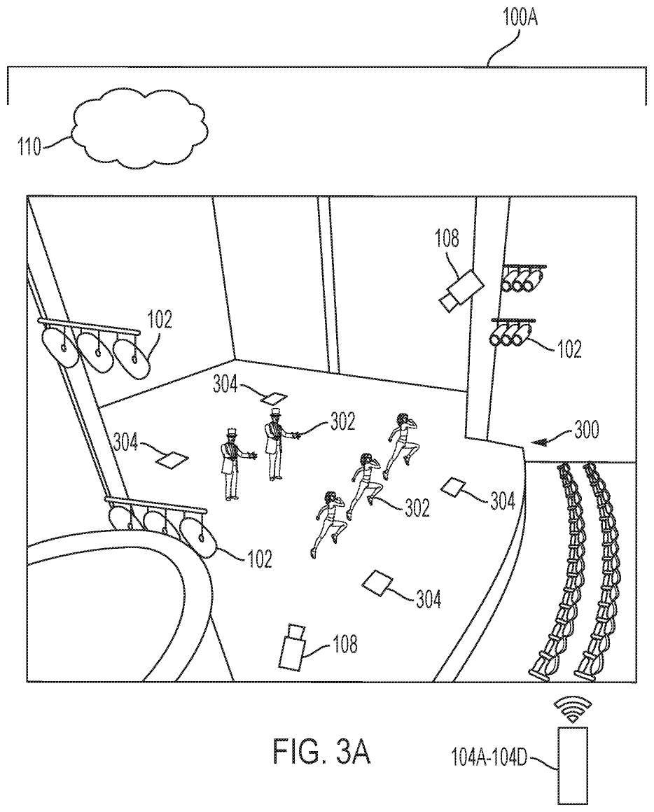

FIG. 3 illustrates the lighting fixtures 102, the user input device 104A-104D, the control board 106, and the cameras 108 in a venue 300. The cameras 108 capture the physical characteristics and/or movement of an object 302 as object data, such as a scenery component or a performer, during a rehearsal, a show, a demonstration, or the like (e.g., the cameras 108 are mounted at known locations in the venue 300 and record video of the moving objects). Additional sensors or markers can be used to track position and orientation of the objects 302 to augment the data that is recorded with the cameras 108 to improve accuracy. These sensors or markers may include, for instance, one or more proximity sensors, radio-frequency identification (“RFID”) tags and sensors, ultra-wide band (“UWB”) sensors, one or more LIDAR sensors, or the like. Further, one or more reference points 304 may be indicated with a marker to be detected by the cameras 108. The reference points 304 can establish relative locations of the objects 302 regarding their surroundings and can be helpful in calibration of the lighting fixtures 102. The controller 200 receives scan data from the cameras 108 to gather input about the physical characteristics and/or movement of the objects 302.

FIG. 3A illustrates the system 100A and a venue 300. As discussed above, the system 100A omits the control board 106, and the user input device 104A-104D is configured to directly communicate with the lighting fixtures 102 and the cameras 108.

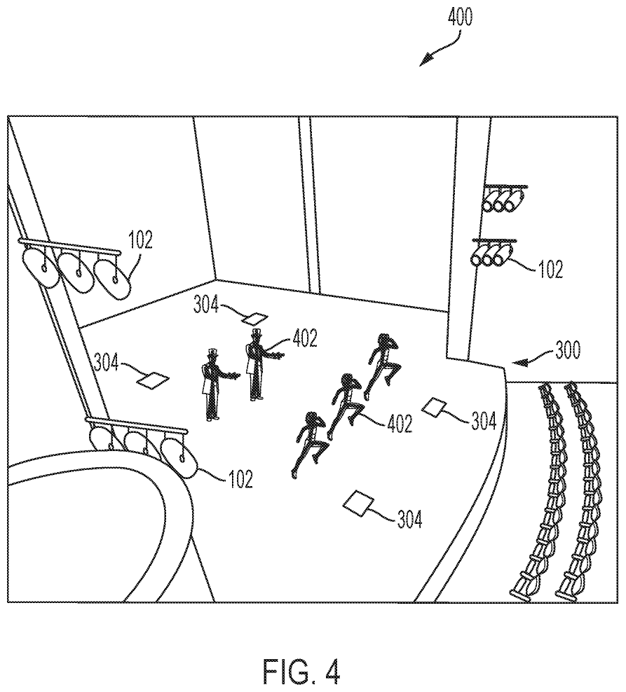

FIG. 4 illustrates an example application screen 400 showing the objects 302 in a stage of digitization. In some embodiments, the application screen 400 is viewed as a virtual reality environment or an augmented reality environment. In some embodiments, this stage of digitization is not shown on a screen. In some embodiments, this example application screen 400 is projected on stage with a video projector. The controller 200 processes the input image or scan data from the cameras 108 and extracts the objects 302 (e.g., the controller 200 analyzes images or recorded video with a computer vision algorithm to extract three-dimensional skeletal data of the moving elements such as figures or objects). Once extracted, each discrete object 302 is digitized as a separate three-dimensional object. In some embodiments, the objects 302 (shown in FIGS. 3 and 3A) are digitized into wire frame elements, or kinematic chains 402 (shown in FIG. 4). In some embodiments, the digitization is accomplished by an algorithm for analyzing and interpreting data received from the cameras 108 including, for instance, using one or more computer vision techniques.

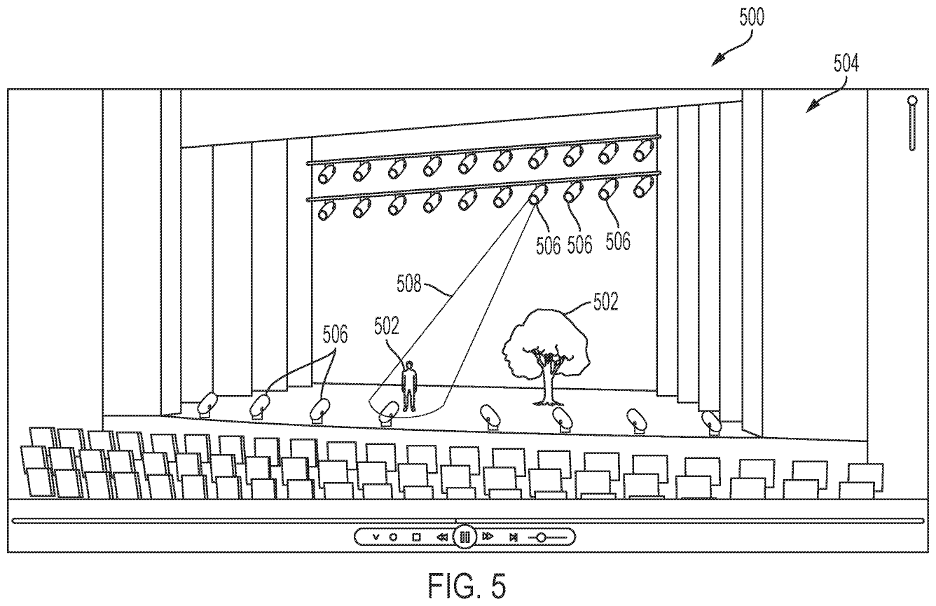

FIG. 5 illustrates another example application screen 500 in which the wire frame elements 402 of the objects 302 are converted into virtualized bodies 502 displayed within an interactive environment 504. In some embodiments, the interactive environment 504 is displayed as either a virtual reality or augmented reality interface on, for instance, the user device 104A-104D. Each virtualized body 502 may be rendered in a manner that replicates the appearance of the originally recorded object 302 in a three-dimensional format. In other embodiments, the virtualized body 502 appears completely different from the object 302. The virtualized body 502 may also be the same general image as the wire frame elements 402, or it may be converted into an image that is completely different from the wire frame elements 402. For instance, an object 302 (e.g., a performer) may be captured with the cameras 108 while the performer 302 is wearing street clothes during a normal rehearsal in the venue 300. The wire frame elements 402 are then extracted from the images of the performer 302, and the virtualized body 502 is rendered as the performer 302 but in the outfit or costume the performer 302 will be wearing for the event. As such, the lighting designer interacts with what amounts to a three-dimensional recording of a dress rehearsal when making lighting decisions within the interactive environment 504. Further, different optional costumes may be evaluated with regard to a particular desired lighting visual to determine which costume would work best for the given performer 302 in the show.

The interactive environment 504 includes one or more virtual lighting fixtures 506 with which the user interacts to virtually control lighting in the interactive environment 504. In some embodiments, the interactive environment 504 additionally or alternatively includes images of one or more actual lighting fixtures 102 combined with interactive virtual elements in an augmented reality interactive environment 504. The virtual elements may be selected or controlled by user input in the interactive environment 504 to control the virtual lighting or virtual lighting fixtures in the interactive environment 504 (e.g., follow spot, fading, focus, color, brightness, intensity, saturation, shape, position, direction, movement, projected images, projected video, special effects, strobe, etc.). Virtual light beams 508 can be added, removed, and otherwise altered until the desired lighting visuals are achieved. The user can also designate which virtual lighting fixture 506 (or actual lighting fixture 102) provides each of the virtual light beams 508. This operation can be useful, for instance, when the user wishes to decide when each of the lighting fixtures 102 operates during a performance. With such control inputs, the user can coordinate multiple lighting fixtures 102.

In the virtual interactive environment 504, the user may coordinate the multiple virtual lighting fixtures 506 to sequentially follow a moving virtualized body 502, such as a virtual representation of the performer 302. For example, a first virtual lighting fixture 506 acts as a follow spot on the virtualized body 502. When the first virtual lighting fixture 506 reaches a range limit on its follow spot capabilities because of the location of the virtualized body 502, a second virtual lighting fixture 506 takes over as the follow spot. As a result, the desired virtual lighting visuals can accurately represent and account for the real-world limitations of lighting fixtures 102 at the particular venue 300.

As changes are made by the user through interaction with the virtual controls within the interactive environment 504, the virtual light beams 508 will also change, thereby altering the way the virtual light beams 508 interact with the virtualized body 502. With this functionality, the user can see an accurate approximation of what the lighting visual will accomplish while taking into account the performer's clothing, body language, expression, or the like. Some or all of the originally-recorded performance can also be imported into the interactive environment 504, and the user plays through the performance (with or without added lighting visuals) in the same manner as a video. For instance, the performance in the interactive environment 504 may be scrubbed, rewound, fast forwarded, trimmed, shuffled, paused, or the like. The alterations of the lighting in the interactive environment 504 can be made while the virtual recording is paused, while the virtual recording is playing at 1:1 time, while the virtual recording is playing at a slower than normal pace or faster than normal pace, or the like. The virtual recording may be paired with corresponding audio to provide a fully immersive experience for the user to make lighting design decisions. Further, timecode synchronization (e.g., Society of Motion Picture and Television Engineers [“SMPTE”] linear time code [“LTC”] or musical instrument digital interface [“MIDI”] timecode [“MTC”]) and generation may be utilized for one or more features of the interactive environment 504.

Once the user input controls are finalized in the interactive environment 504, the now-altered virtual recording can be archived as a file. This file can be revisited and further altered, marked with timestamps to highlight particular segments of the altered virtual recording, shared amongst lighting designers, lighting console operators, lighting/system technicians, or the like.

In other embodiments, the interactive environment 504 is an augmented reality environment instead of a fully virtual environment. For instance, the lighting designer wears an augmented reality headset at the venue 300 and views the virtualized body 502 and the virtual light beams 508. The user manipulates the virtual light beams 508 as images superimposed on the images or video feed (e.g., still images, live images, or video) of the actual venue 300. In other embodiments, the user manipulates the actual lighting fixtures 102 with real lighting at the venue 300 with only the virtualized body 502 superimposed on the images or video feed of the actual venue. The interactive environment 504 may render the virtualized body 502 differently in response to the actual lighting changes made in the real-world venue 300. Additionally or alternatively, the user views the augmented reality environment with a smartphone, or the augmented reality environment is projected by a video projector.

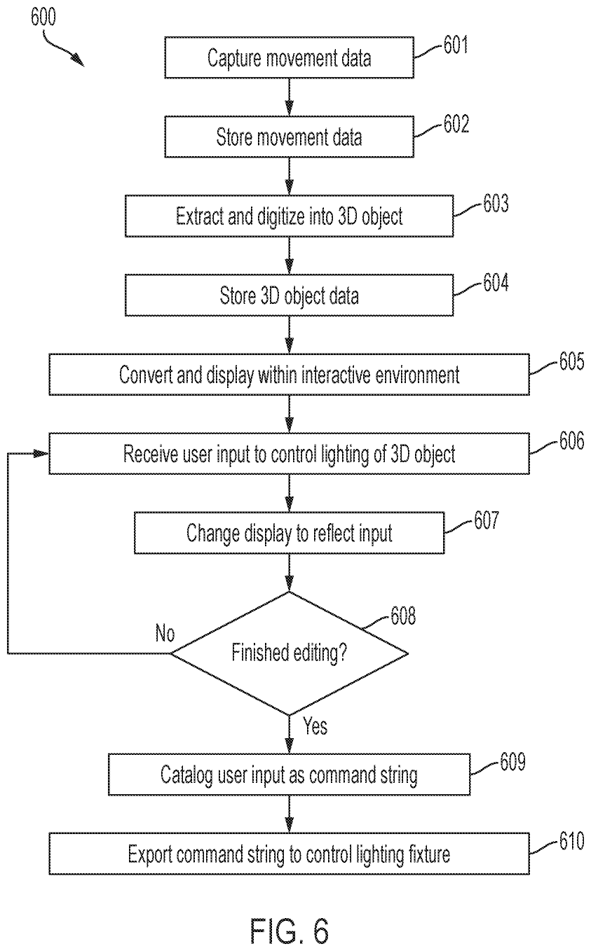

FIG. 6 illustrates a method 600 of generating a lighting design for an event at the venue 300 performed by the system 100, 100A. The method 600 includes capturing the movement data of one or more objects 302 (STEP 601). The objects 302 include performers during a dress rehearsal, scenic elements moved about in the manner they will be moved for the event, or the like. The method 600 further includes the controller 200 storing this movement data for later use by the user or another user (STEP 602).

The method 600 also includes the controller 200 extracting each object 302 from a static background and digitizing each object 302 as a three-dimensional object, such as the wireframe element 402 (STEP 603). The three-dimensional object 402 is also stored for later use by the user or another user (STEP 604).

The method 600 further includes the controller 200 converting the wireframe element 402 into the virtualized body 502 and displaying the virtualized body 502 as a dynamic display within the interactive environment 504 (STEP 605).

Once the interactive environment 504 is prepared, the method 600 further includes the controller 200 receiving a user input to control one or more virtual lighting fixtures 506 to alter the lighting data within the interactive environment 504 (STEP 606). After the user input control has been received, the virtual lighting (via virtual light beams 508) of the dynamic display including the virtualized body 502 is changed to reflect the user's changes (STEP 607).

After the changes have been made, the user may choose (STEP 608) to continue editing the lighting design in the interactive environment 504. If more editing is desired, the method 600 returns to STEP 606. If no more editing is desired, the user can finalize the now- altered virtual recording showing the virtualized body 502 with the virtual lighting changes. The method 600 then proceeds to STEP 609.

Once the user has confirmed the virtual lighting display within the interactive environment 504 is finalized, the controller 200 catalogs (e.g., stores to memory 210) the user input data in the form of a command string (STEP 609). The command string includes information for controlling the real-world lighting fixtures in the venue 300, which is based on the user input received via the interactive environment 504 (STEP 609). In some embodiments, the command string includes all the lighting commands for a single static lighting visual, lighting commands for multiple lighting visuals in sequence, one or more lighting commands for a dynamic lighting visual, or the like. With regard to sequences of static lighting visuals and dynamic lighting visuals, the command string includes timing data for each lighting command.

In some embodiments, the method 600 further includes the controller 200 exporting the command string to control at least one lighting fixture 102 either directly or indirectly through a control board 106 or user input device 104A-104D (STEP 610). As such, a user can design the lighting visuals in the interactive environment 504 for an upcoming event at the venue 300, edit the design as desired, finalize the design, and export all of the show's lighting visuals to control the lighting fixtures 102 at the venue 300.

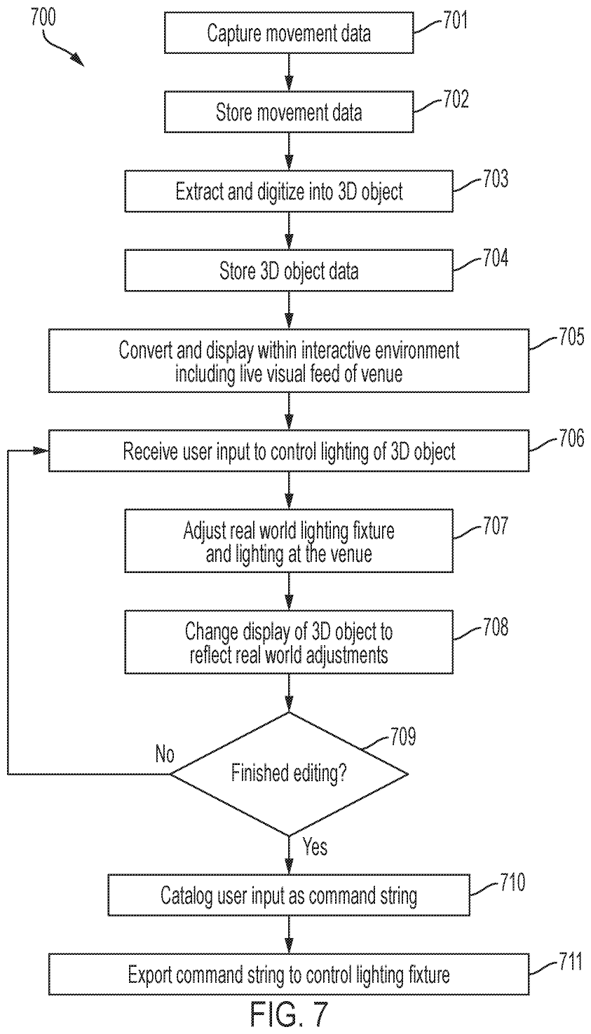

FIG. 7 illustrates another method 700 of generating a lighting design for an event at the venue 300 performed by the system 100, 100A. The method 700 includes capturing the movement data of one or more objects 302 (STEP 701). The objects 302 include performers during a dress rehearsal, scenic elements moved about in the manner they will be moved for the event, or the like. The method 700 further includes the controller 200 storing this movement data for later use by the user or another user (STEP 702).

The method 700 also includes the controller 200 extracting each object 302 from a static background and digitizing each object as a three-dimensional object, such as the wireframe element 402 (STEP 703). The three-dimensional object 402 is also stored for later use by the user or another user (STEP 704).

The method 700 further includes the controller 200 converting the wireframe elements 402 into the virtualized bodies 502 and displaying the virtualized bodies 502 as a dynamic display within the interactive environment 504 that includes a live visual feed of the venue 300 (STEP 705).

Once the interactive environment 504 is prepared, the method 700 further includes the controller 200 receiving a user input to alter the lighting of the virtualized bodies 502 within the interactive environment 504 (STEP 706). After receipt of the user input control, the actual lighting in the venue 300 changes by adjusting the real-world lighting fixtures 102 (STEP 707). The method 700 also includes the controller 200 altering the dynamic display including the virtualized bodies 502 to reflect the lighting changes in the real-world venue 300 (STEP 708).

After the changes have been made, the user may choose (STEP 709) to continue editing the lighting design in the interactive environment 504. If more editing is desired, the method 700 returns to STEP 706. If no more editing is desired, the user can finalize the now- altered lighting of the virtualized bodies 502 with the corresponding real-world settings of the lighting fixtures 102. The method 700 then proceeds to STEP 710.

Once the user has confirmed the lighting display within the interactive environment 504 is finalized, the controller 200 catalogs (e.g., stores in the memory 210) the user input data in the form of a command string (STEP 710). The command string includes information for controlling the real-world light fixtures 102 in the venue 300. In some embodiments, the command string includes all the lighting commands for a single static lighting visual, lighting commands for multiple lighting visuals in sequence, one or more lighting commands for a dynamic lighting visual, or the like. With regard to sequences of static lighting visuals and dynamic lighting visuals, the command string includes timing data for each lighting command.

In some embodiments, the method 700 further includes the controller 200 exporting the command string to control at least one lighting fixture 102 either directly or indirectly through a control board 106 or user input device 104A-104D (STEP 711). As such, a user can design the lighting visuals in the interactive environment 504 for an upcoming event at the real- world venue 300, edit the design as desired, finalize the design, and later export all of the show's lighting visuals to control the lighting fixtures 102 at the venue 300.

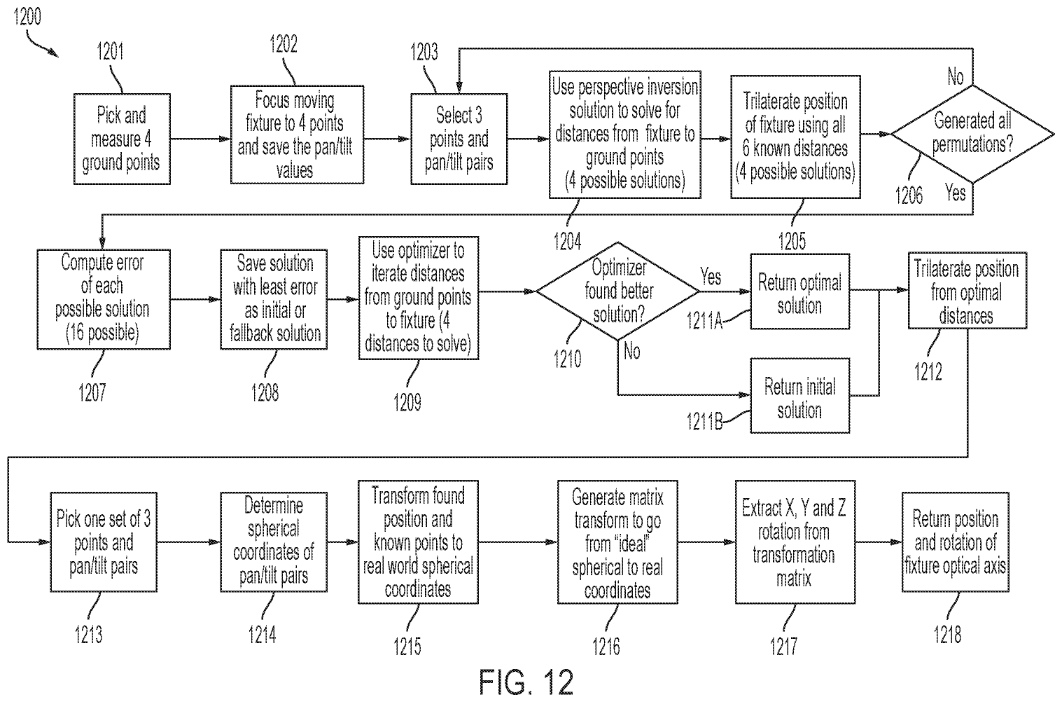

The user input device 104A-104D can be paired with a three-dimensional model space for locating objects within the three-dimensional model space, as described with respect to FIGS. 12-18. By being able to accurately locate objects from the real-world in a three-dimensional model space, the interactive environment 504 can accurately represent the real-world and correctly position virtualized bodies 502, virtual light fixtures 506, and virtual light beams 508 in the interactive environment 504 with respect to real-world elements of the venue 300.

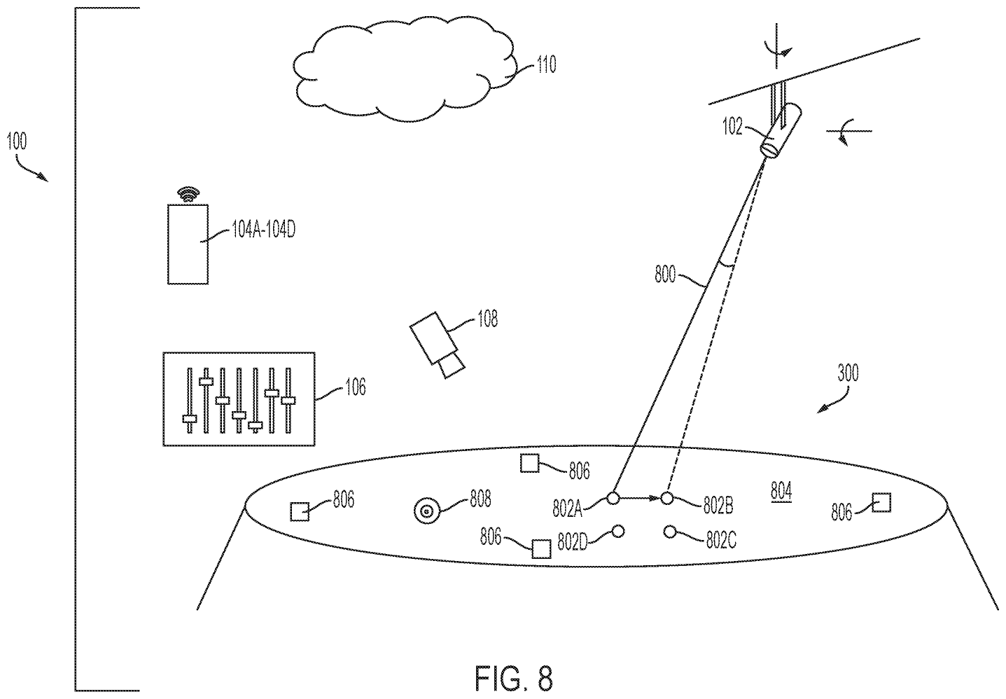

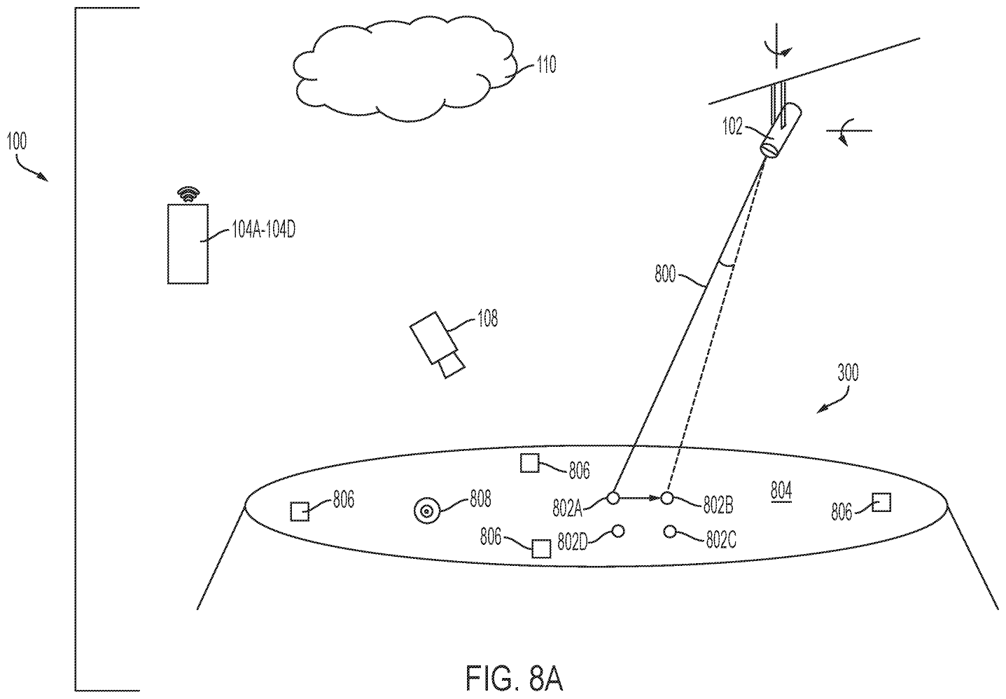

FIG. 8 illustrates the control board 106, the lighting fixture 102, the camera 108, and the user input device 104A-104D of the system 100 in the venue 300. The user input device 104A-104D directs the lighting fixture 102 such that a lighting beam 800 projecting from the lighting fixture 102 strikes at discrete locations 802A, 802B, 802C, 802D on a stage surface 804 at the venue 300. A user may directly control the movement of the lighting fixture 102, or the lighting fixture 102 may move according to a preprogrammed pattern.

FIG. 8A illustrates the system 100A in the venue 300. As described above, the system 100A removes the control board 106, and the user input device 104A-104D is configured to directly communicate with the lighting fixture 102 and the camera 108.

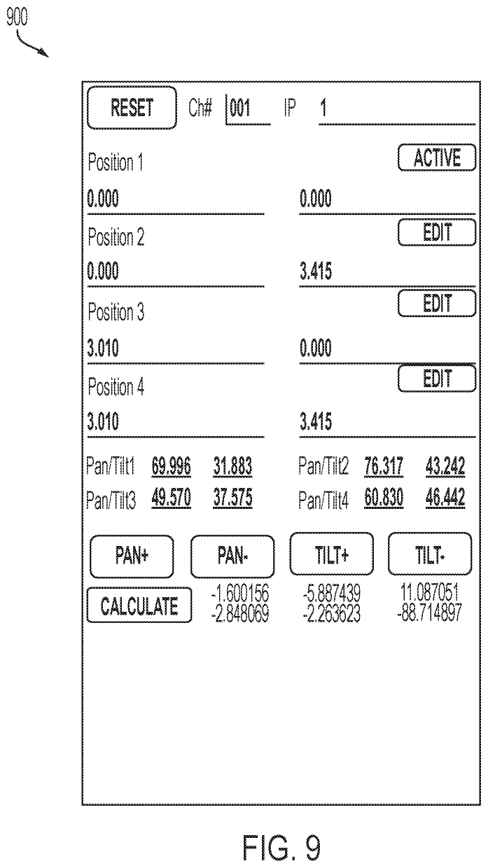

With reference to the system 100 and/or the system 100A, FIG. 9 illustrates an example of an application interface screen 900 for use with the user device 104A-104D that receives user input to control the movement of the lighting fixture 102 for synchronizing the position of the lighting beam 800 with the discrete locations 802 on the ground in the venue 300. In some embodiments, the lighting beam 800 moves to at least three locations (802A, 802B, 802C). Other embodiments include the lighting beam 800 moving to a fourth location 802D. Other embodiments include the lighting beam 800 moving to more than four locations 802. The movement of the lighting fixture 102 is accomplished by changing the angle of the lighting fixture 102 by either panning or tilting the lighting fixture 102. The controller 200 is configured to store the angular change data corresponding to the lighting fixture 102 movement to move the lighting beam 800 from the first location 802A to the second location 802B, from the second location 802B to the third location 802C, and so on.

With reference to FIGS. 8 and 8A, the controller 200 is further configured to store the coordinate data of each of the at least three locations 802 on the surface 804. In some embodiments, the coordinate data is input by a user, such as when the user directly controls the movement of the lighting fixture 102. In some embodiments, the coordinate data is determined by the controller 200 by calculating a position of the user device 104A-104D relative to one or more reference points 806 with scan data from one or more cameras 108. The cameras 108 may be integrated into the user device 104A-104D, wirelessly connected to the user device 104A-104D, connected by wire to the user device 104A-104D, or otherwise associated. The reference points 806 provide orientation and distance information for the user device 104A-104D. In some embodiments, the reference points 806 are visible marks on the surface 804. Other embodiments include at least one reference point 806 in the form of a sensor readable marker that is not visible to the human eye (e.g., an infrared marker). Using known computer vision, image recognition, and scanning applications (e.g., a simultaneous localization and mapping [“SLAM”] program), the controller 200 can calculate distances between designated points on the surface 804 after the user device 104A-104D has been properly calibrated with the reference points 806.

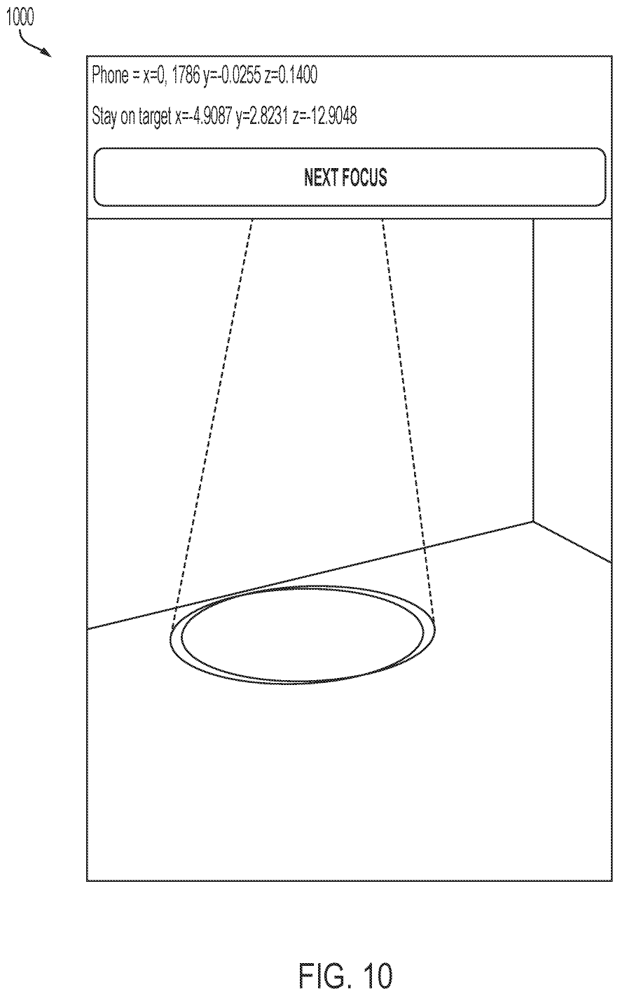

To determine the discrete locations 802 where the lighting beam 800 contacts the surface 804 without user input information regarding the locations, the controller 200 is configured to determine a centroid of the lighting beam through scan data provided by the camera 108. An example of the scan of the surface 804 that the camera 108 may perform is shown in FIG. 10. The centroid can be found regardless of angle of attack of the lighting beam 800 through any appropriate method including, for example, light intensity analysis of the surface 804. As such, at each of the discrete locations 802, the image data of the lighting beam 800 is captured by the camera 108 and analyzed by the controller 200. Once the analysis is complete, the controller 200 is configured to return values for the coordinate data of each of the discrete locations 802 relative to the one or more reference points 806.

Because the lighting fixture 102 control is paired with the controller 200, the controller 200 is able to quantify the change in angle each time the lighting fixture 102 moves. Although this change in angle is known to the controller 200 as a relative angle of the lighting fixture 102 from one position to another and not an absolute angle relative to the surface 804, the absolute angles can be found through mathematical calculations using a perspective inversion solution described generally below.

To calculate the position of the lighting fixture 102 relative to the stage surface 804, the perspective inversion solution uses the length of each side of a triangle that is traced by the lighting beam 800 on the stage surface 804 and the changes in angle of the lighting fixture 102 that created that triangle. The length of the sides of the triangle can be found with the at least three locations 802 coordinate data input and/or calculation as described above. The angles are known by virtue of the controller 200 controlling the lighting fixture 102, as described above.

Because there can be a degree of uncertainty present when calculating the position of the lighting fixture 102 based on only three discrete locations 802A, 802B, and 802C, some embodiments include a fourth discrete location 802D. With four discrete locations 802A, 802B, 802C, 802D, the controller 200 is configured to sequentially determine sets of three discrete locations (e.g., 802A, 802B, and 802C first, 802B, 802C, and 802D second, 802A, 802C, and 802D third, etc.) and is configured to return a value for the lengths of the lighting beam 800 as it existed when it was directed to each of the discrete locations 802A, 802B, 802C, 802D. The controller 200 is then configured to compare these results as they overlap in order to calculate the values with greater certainty. Other embodiments include more than the four discrete locations 802. Such embodiments add even further accuracy to the calculation. Once the length of the lighting beam 800 from the lighting fixture 102 to each individual discrete location 802A, 802B, 802C, 802D is found, the controller 200 is configured to, for example, trilaterate or quadrilaterate the location of the lighting fixture 102. The point at which the spheres of possible solutions for the discrete locations 802A, 802B, 802C, 802D cross is designated as the location of the lighting fixture 102. This calculation actually returns two results—one above the stage surface 804 and one below the stage surface 804. The controller 200 is configured to discard the result below the stage surface 804.

In some embodiments of the system 100 and/or the system 100A, the controller 200 is further configured to run an optimizer operation with the possible positions of the lighting fixture 102. Because the measurements could be off slightly or the control feedback may have noise in the signal, an optimizer operation can more accurately determine the position of the lighting fixture 102 (e.g., improve accuracy of the position of the lighting fixture). The optimizer runs calculations using the law of cosines with the values it has from previously running the perspective inversion solution. The optimizer takes the length of the lighting beam 800 from the lighting fixture 102 to each individual discrete location 802A, 802B, 802C, 802D, combines that data with the known changes in angle of the lighting fixture 102, and determines possible values for the distances on the stage surface 804 between the discrete locations 802A, 802B, 802C, 802D. Because these distances are known through measurement or other methods described above, the optimizer compares these known distances with the determined distances to gauge the accuracy of the results from the perspective inversion solution.

An example of an appropriate optimizer operation is a limited memory Broyden-Fletcher-Goldfarb-Shanno (“LBFGS”) optimizer, although other optimizer operations may be used. If the optimizer operation returns results that converge to a value, that particular value is determined to be more accurate than the initial value. If the results do not converge to a value and instead scatter, the initial value is returned as accurate enough to continue without further attempting the optimizer operation. After these steps, the location of the lighting fixture 102 is again trilaterated (or quadrilaterated). This location is then output as the most accurate estimation of the position of the lighting fixture 102 relative to the stage surface 804 (or the reference points 806).

After the controller 200 has determined the position of the lighting fixture 102, the controller 200 is configured to determine the orientation of the lighting fixture 102 relative to the stage surface 804. In some embodiments, however, the position calculation for the lighting fixture 102 and the orientation calculation for the lighting fixture 102 are both accomplished with the optimizer operation.

The controller 200 uses any three of the discrete locations 802 on the stage surface 804 and the corresponding relative angular change information from the control of the lighting fixture 102. The relative angular change information includes pan, tilt, or both pan and tilt. The controller 200 determines spherical coordinates of the discrete locations 802 receiving the lighting beam 800 as the lighting fixture 102 is oriented in each position. These spherical coordinates are relative spherical coordinates, in that they include pan and tilt angles of the lighting fixture 102 relative to the axis of the lighting beam 800, and the origin is the position of the lighting fixture 102 (i.e., the focal point of the lighting beam 800).

The controller 200 is configured to translate the known Cartesian coordinates of the found position of the lighting fixture 102 and the known discrete locations 802 relative to the reference points 806 into real-world spherical coordinates with the lighting fixture 102 as the origin. Some embodiments include the reference points 806 being one of the known discrete locations 802 in this calculation.

The controller 200 is then configured to perform a matrix transformation utilizing both the relative spherical coordinates and the real-world spherical coordinates to translate the relative spherical coordinates of the orientation of the lighting fixture 102 at each position into real-world spherical coordinates (e.g. relative to a reference plane, which may be referred to as absolute spherical coordinates). Once this relationship is determined, the yaw, pitch, and roll information of the orientation of the lighting fixture 102 relative to the stage surface 804 is extracted. In some embodiments, the yaw, pitch, and roll may be referred to as absolute angles of the lighting fixture 102 with reference to the surface 804, which includes a plane of the discrete locations 802A, 802B, 802C, and 802D. This information is the absolute orientation of the lighting fixture 102 regardless of mounting methods.

After the above calculations have been completed, the controller 200 is configured to present the results as the indicated position and orientation of the lighting fixture 102 (e.g., the controller 200, or a user device 104A-104D is paired with the three-dimensional model space of the venue). With this information, the controller 200 can alter image data relating to the lighting fixture 102 and the lighting beam 800 in an interactive environment and control the lighting fixture 102. Once the lighting fixtures 102 in the venue 300 have been identified, classified, and located, the above calculated information can be used to implement transitions of various styles.

With continued reference to FIGS. 8 and 8A, the above calculated information can also be used to alter command string data sent to the lighting fixture 102 in order to translate locations 808 designated on the surface 804 into appropriate angular changes of the lighting fixture 102 to cause the lighting beam 800 to be directed to the designated locations 808. Some embodiments of the system 100, 100A include the controller 200 configured to control the lighting fixture 102 according to the altered command string data.

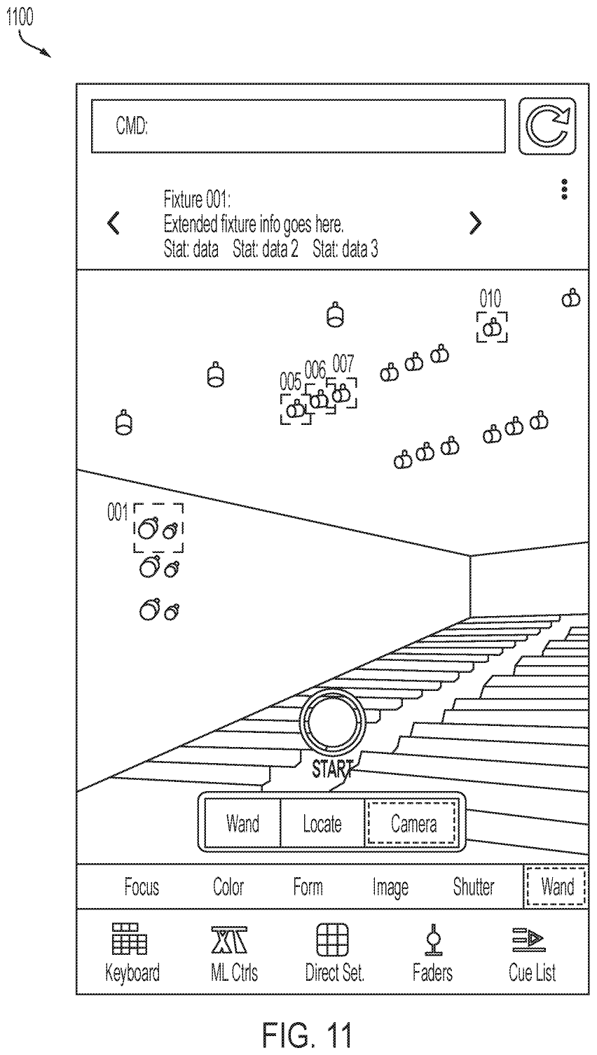

In some embodiments, the indication of the locations 808 is made on a touchscreen of the user device 104A-104D utilizing an augmented reality interface (through, for instance, an application interface screen 1100 as shown in FIG. 11). In such an interface, the user sees the surface 804 on the touchscreen and may point to a destination 808 on the surface 804 on the touchscreen. The controller 200 is configured to then convert this indicated portion of the screen into an equivalent position of the destination 808 on the surface 804. The controller 200 is configured to relate the orientation of the capture view of the camera 108 with the surface 804 based on a calibration with one or more reference points 806. Additionally or alternatively, the system 100, 100A uses one or more inertial measurement units (“IMUs”) coupled with the user device 104A-104D to determine the position and orientation data of the user device 104A-104D. Cameras 108 may not be necessary in this instance, but the user device 104A-104D would be paired to the three-dimensional model space by positioning and orienting the device in a known home arrangement and recording the data from the IMUs at that home arrangement. In embodiments of the system 100, 100A using augmented reality libraries (e.g., ARCore, ARKit, etc.), both IMUs and cameras 108 can be utilized to improve accuracy of the data.

Once the real-world position of the destination 808 on the surface 804 is determined, the controller 200 is configured to send a control signal to one or more motors to actuate movement of the lighting fixture 102. The lighting fixture 102 moves to the appropriate orientation to project the lighting beam 800 at the destination 808. For example, the controller 200 is configured to translate the real-world Cartesian coordinates of the destination 808 into the altered control string described above to operate the lighting fixture 102 such that the lighting beam 800 moves appropriately in the three-dimensional model space.

In some embodiments of the system 100, 100A, the indication of the desired destination 808 for the lighting beam 800 on the surface 804 at the venue 300 can be made by aiming the center of the capture view of the camera 108 at the destination 808. As described above, the controller 200 is configured to convert this center of the capture view into an equivalent positon of the destination 808 on the actual surface 804. In this configuration, the indication of the desired destination 808 may be actuated by a distinct command, such as a voice command, the press of a button, or the like. Additionally or alternatively, the indication of the desired destination 808 is switched to a continual or continuous mode, such that the desired destination 808 moves simultaneously or with some delay relative to the changing capture view of the camera 108 as the camera 108 is moved throughout the venue 300. In some embodiments, this mode can be used as a follow spot control.

In some embodiments of the system 100, 100A, the indication of the desired destination 808 of the lighting beam 800 on the surface 804 at the venue 300 is made by pointing an end of the user device 104A-104D in a direction with the camera view of the camera 108 pointing in an orthogonal direction. With a smartphone 104D, for instance, a user could point the top end of the smartphone 104D at the desired location 808 while the camera 108 is directed toward the surface 804. In this configuration, the lighting beam destination 808 may be set at a constant distance, potentially designated by the user, from the end of the smartphone 104D or from the center of the capture view of the camera 108 in an orthogonal direction from the direction of the capture view. In some embodiments, the user device 104A-104D determines the location of the desired destination 808 by pointing the end of the user device 104A-104D to the desired destination 808, and using the known location (coordinates) of the user device 104A-104D in the venue along with a tilting angle of the device 104A-104D relative to the surface 804 (e.g., determined using internal IMUS of the device 104A-104D) to determine the location of the of the desired destination 808 in the venue 300.

In some embodiments of the system 100, 100A, the indication of the desired destination 808 of the lighting beam 800 is set as the location of the user device 104A-104D itself. The controller 200 determines the location of the user device 104A-104D based on the capture data from the camera 108. This data is processed to calculate the location relative to one or more reference points 806. The controller 200 is configured to designate the current location of the user device 104A-104D relative to the reference points 806 as the destination 808. As described above, the indication of the desired destination 808 as the location of the user device 104A-104D can be actuated by a distinct command. Additionally or alternatively, the indication of the user device 104A-104D as the destination 808 may be switched to a continuous or continual mode.

As shown in FIG. 12, the system 100, 100A may operate according to a method 1200 to calculate the arrangement information of the lighting fixture 102. First, the user chooses and measures four discrete physical locations 802A, 802B, 802C, 802D on the surface 804 (STEP 1201).

The user then focuses the lighting fixture 102 at each of the four discrete locations 802A, 802B, 802C, 802D and saves the resulting angular change values for the pan and tilt of the lighting fixture (STEP 1202). Next, either the controller 200 or the user selects any three of the four discrete locations 802A, 802B, 802C, 802D and the corresponding angular changes the lighting fixture 102 made to direct the lighting beam 800 to each of the respective selected discrete locations 802A, 802B, 802C, 802D (STEP 1203).

A perspective inversion solution is used to solve for the distances from the discrete locations 802A, 802B, 802C, 802D on the surface 804 to the lighting fixture 102 (STEP 1204). Once all the values for the distances have been determined, the position of the lighting fixture 102 is trilaterated (STEP 1205).

The controller 200 then determines whether all of the possible combinations of three of the discrete locations 802A, 802B, 802C, 802D and corresponding angular changes have been calculated with the perspective inversion solution (STEP 1206). If not all possible combinations have been calculated, the method 1200 returns to STEP 1203 to complete the other possible combinations.

If, at STEP 1206, all possible combinations have been calculated, the method 1200 proceeds to compute an error of each possible solution found (STEP 1207). Next, the controller 200 saves the solution with the fewest errors as the best initial solution for the position of the lighting fixture 102 (STEP 1208). The best initial solution is then used as an input to attempt to optimize (e.g., improve accuracy of) the result by running calculations using the law of cosines (STEP 1209). The controller 200 then determines whether the optimization operation converged on a solution (STEP 1210).

If the optimization operation converged on a solution, the optimal solution is returned as the solution for the length of the light beam 800 from each of the discrete locations 802A, 802B, 802C, 802D to the lighting fixture 102 (STEP 1211A) instead of the previous best initial solution from STEP 1208. If the optimization operation did not converge on a solution, the controller 200 ignores the optimization operation and returns the best initial solution from STEP 1208 (STEP 1211B). The controller 200 then determines the position of the lighting fixture 102 through trilateration with the best available lengths (STEP 1212).

Now that the position of the lighting fixture 102 has been determined, the controller 200 selects one set of three of the discrete locations 802 and the corresponding changes in angle of the lighting fixture 102 (STEP 1213). The spherical coordinates of the discrete locations 802 are found with the lighting fixture 102 serving as the point of origin (STEP 1214). Then, the known Cartesian coordinates of the discrete locations 802 and the lighting fixture 102 are converted to real-world spherical coordinates (STEP 1215) with the lighting fixture 102 as the origin. A matrix transformation is performed to translate the relative spherical coordinates of the lighting fixture 102 into absolute spherical coordinates (STEP 1216). The yaw, pitch, and roll information of the lighting fixture 102 is then determined and extracted (STEP 1217). The controller 200 then returns the position and orientation of the lighting fixture 102 relative to the surface 804 and the reference point 806 (STEP 1218).

Although STEPS 1213-1217 were described above, some embodiments of the method 1200 includes the position calculation for the lighting fixture 102 and the orientation calculation for the lighting fixture 102 both being accomplished during the optimization step (STEP 1209) and proceeding from STEP 1212 directly to STEP 1218.

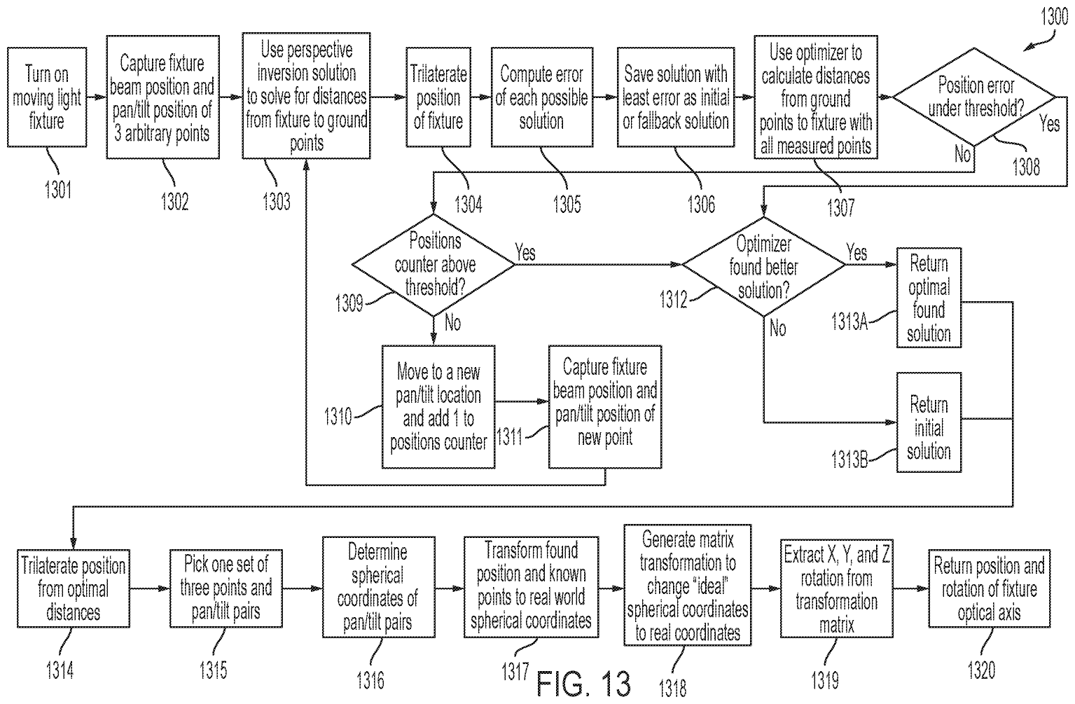

With reference to FIG. 13, the system 100, 100A may additionally or alternatively operate according to a method 1300 to calculate the arrangement information of the lighting fixture 102. First, the lighting fixture 102 is turned on (STEP 1301). A control routine is operated, and the controller 200 records the set angle of the lighting fixture 102 while the camera 108 captures the discrete location 802 of the lighting beam 800 on the surface 804 at three arbitrary points (STEP 1302). The controller 200 then calculates the distances from the discrete locations 802 to the lighting fixture 102 (STEP 1303). These distances are used to trilaterate the position of the lighting fixture 102 (STEP 1304).

The method 1300 then moves to STEP 1305, where the error of each possible solution is calculated. The controller 200 saves the solution with the least errors as the best initial solution for the position of the lighting fixture 102 (STEP 1306). The best initial solution is used as an input to attempt to optimize the result by running calculations using the law of cosines (STEP 1307). The controller 200 then determines whether the initial solution (after optimization) for the position of the lighting fixture 102 is known with enough accuracy to be below an error threshold (STEP 1308).

If the position error is not less than the error threshold at STEP 1308, the controller 200 determines whether the number of discrete locations 802 recorded by a positions counter is above a threshold value (STEP 1309). The threshold positions value may be any appropriate number including, for instance, ten discrete locations 802. If, at STEP 1309, the positions counter is less than the threshold value, the controller 200 moves the lighting fixture 102 to a new angular position (STEP 1310) and increases the value stored in the positions counter by one. Next, the controller 200 captures data corresponding to another discrete location 802 (STEP 1311). After capturing the data corresponding to another discrete location 802 (STEP 1311), the method 1300 returns to STEP 1303 to recalculate the distances from the discrete locations 802 to the lighting fixture 102. The method 1300 continues through STEPS 1304-1307.

This portion of the method 1300 loops until either the initial solution (after optimization) is found within the error threshold or the number stored in the positions counter is above the threshold value. In some embodiments, the addition of the fourth discrete location 802D makes the initial solution fall within the error threshold. In other embodiments, five or more discrete locations 802 are used. In other embodiments, only the initial three discrete locations 802A, 802B, and 802C are used to get an initial solution that is within the error threshold. If, at STEP 1308, position error is less than or equal to the error threshold, the method 1300 continues to STEP 1312. Similarly, if the new initial solution found at STEP 1306 is sufficiently accurate after optimization and after the method 1300 has continued through the loop of STEPS 1307-1311 and 1303-1308, the method 1300 continues to STEP 1312. Further, if the initial solution found at STEP 1306 and optimized at STEP 1307 is not within the error threshold but the positions counter has a value that is above the positions threshold, the method 1300 continues to STEP 1312 without trying further discrete locations 802.

The controller 200 then determines whether the optimization operation converged on a solution (STEP 1312). If the optimization operation converged on a solution, the optimal solution is returned as the solution for the lengths of the light beam 800 from each of the discrete locations 802 to the lighting fixture 102 (STEP 1313A) instead of the previous best initial solution from STEP 1306. If the optimization operation did not converge on a solution, the controller 200 ignores the optimization operation and returns the best initial solution from STEP 1306 (STEP 1313B). The controller 200 then calculates the position of the lighting fixture 102 for a final time through trilateration with the best available values for the lengths from the discrete locations 802 to the lighting fixture 102 (STEP 1314).

With the position of the lighting fixture 102 determined, the controller 200 selects one set of three of the discrete locations 802 and the corresponding changes in angle of the lighting fixture 102 (STEP 1315). The spherical coordinates of the discrete locations 802 are found with the lighting fixture 102 serving as the point of origin (STEP 1316). Then, the known Cartesian coordinates of the discrete locations 802 and the lighting fixture 102 are converted to real-world spherical coordinates (STEP 1317) with the lighting fixture 102 as the origin. A matrix transformation is performed to translate the relative spherical coordinates of the lighting fixture 102 into absolute spherical coordinates (STEP 1318). The yaw, pitch, and roll information of the lighting fixture 102 is then found and extracted (STEP 1319). The controller 200 then determines the position and orientation of the lighting fixture 102 relative to the surface 804 and the reference point 806 (STEP 1320).

Although STEPS 1315-1319 were described above, some embodiments of the method 1300 include the position calculation for the lighting fixture 102 and the orientation calculation for the lighting fixture 102 both being accomplished during the optimization step (STEP 1307) and proceeding from STEP 1314 directly to STEP 1320.

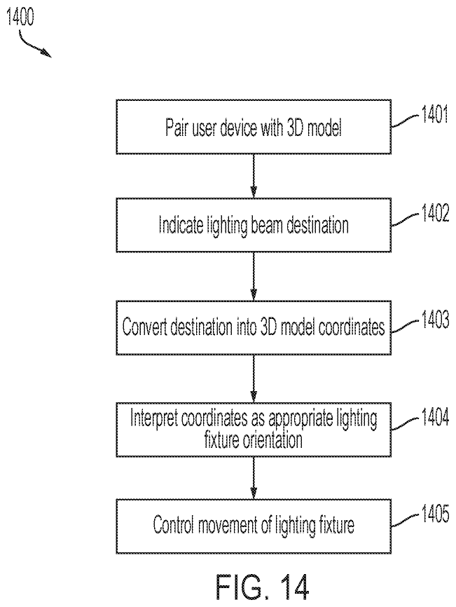

With reference to FIG. 14, a method 1400 of directing a lighting fixture 102 in the venue 300 is shown. The system 100, 100A may additionally or alternatively operate according to the method 1400. The method 1400 begins with pairing the user device 104A-104D in the venue 300 with a three-dimensional model space of the lighting beam 800 and lighting fixture 102 (STEP 1401). This step is accomplished, for instance, by directing the camera 108 such that the capture view of the camera scans at least one of the reference points 806. Once the reference points 806 have been scanned, the controller 200 can determine where the user device 104A- 104D is in the venue 300 and what orientation it has in the venue 300 (e.g., as described above with respect to FIGS. 8 and 8A).

The method 1400 also includes the controller 200 indicating a lighting beam destination 808 (STEP 1402). The lighting beam destination 808 may be designated in, for instance, one of the ways described above. The lighting beam destination 808 is located relative to the capture view of the camera 108. Once the lighting beam destination 808 has been indicated, the method 1400 includes the controller 200 converting the destination indicated by the user device 104A-104D into coordinates at the venue 300 in the three-dimensional model space (STEP 1403). This conversion is made based on the earlier gathered data about the orientation and position of the user device 104A-104D.

After this conversion has been made, the method 1400 includes the controller 200 interpreting the coordinates at the venue 300 for the lighting beam destination 808 relative to lighting fixture arrangement (e.g., positions and orientations), and determining a corresponding lighting fixture 102 arrangement (e.g., using method 1200 or method 1300) that directs the lighting beam 800 appropriately to the lighting beam destination 808 (STEP 1404). The method 1400 then includes the controller 200 controlling actuation of at least one motor coupled to or associated with the lighting fixture 102 to move the lighting fixture 102 according to the determined lighting fixture 102 orientation such that the lighting beam 800 is directed to the lighting beam destination 808 (STEP 1405).

Thus, embodiments described herein provide methods and systems for producing a lighting design for an event at a venue. Various features and advantages of some embodiments are set forth in the following claims.

What is claimed is:

1. A method of generating a lighting design for a venue, the method comprising:
receiving, with an electronic processor, object data based on a detected object in the venue;
displaying, using the electronic processor, the object data as a representation of the detected object in an interactive lighting environment;
receiving, with the electronic processor, a user input via the interactive lighting environment to change lighting data that controls virtual lighting represented in the interactive lighting environment; and
altering, using the electronic processor, the virtual lighting represented in the interactive lighting environment based on the user input.

2. The method of claim 1, wherein the altering of the virtual lighting represented in the interactive lighting environment based on the user input includes changing a brightness of the lighting, changing a color of the lighting, changing a shape of the lighting, changing projected images, changing projected video, changing special effects, changing a strobe, and/or changing a position, direction, or movement of a light beam in the interactive lighting environment.

3. The method of claim 1, further comprising:
storing in a memory, using the electronic processor, a command string based on the user input received via the interactive lighting environment to change lighting data.

4. The method of claim 3, wherein the command string includes timing data for at least one lighting fixture at the venue.

5. The method of claim 3, further comprising:
controlling at least one lighting fixture at the venue based on the command string.

6. The method of claim 1, wherein the interactive lighting environment is superimposed on a video of the venue.

7. The method of claim 1, further comprising:
detecting the detected object with at least one camera.

8. The method of claim 1, wherein the representation of the detected object in the interactive lighting environment is a three-dimensional representation of the detected object.

9. The method of claim 1, wherein the object data is based on a position of the detected object relative to a reference point at the venue.

10. The method of claim 9, further comprising:
detecting the position of the detected object using a sensor.

11. A system for generating a lighting design for a venue, the system comprising:
a display device; and
a controller including an electronic processor connected to a memory, the memory storing instructions that when executed by the electronic processor configure the controller to:
receive object data based on a detected object in the venue,
display the object data as a representation of the detected object in an interactive lighting environment,
receive a user input via the interactive lighting environment to change lighting data that controls virtual lighting represented in the interactive lighting environment, and
alter the virtual lighting represented in the interactive lighting environment based on the user input.

12. The system of claim 11, wherein the virtual lighting represented in the interactive lighting environment is altered to change a brightness of the lighting, change a color of the lighting, change a shape of the lighting, change projected images, change projected video, change special effects, change a strobe, and/or change a position, direction, or movement of a light beam in the interactive lighting environment.

13. The system of claim 11, wherein the controller is further configured to store, in the memory, a command string based on the user input received via the interactive lighting environment to change lighting data.

14. The system of claim 13, wherein the command string includes timing data for at least one lighting fixture at the venue.

15. The system of claim 13, wherein the controller is further configured to control at least one lighting fixture at the venue based on the command string.

16. The system of claim 11, wherein the interactive lighting environment is superimposed on a video of the venue relative to a reference point at the venue.

17. The system of claim 11, further comprising:
at least one camera,
wherein the detected object is detected with the at least one camera.

18. The system of claim 11, wherein the representation of the detected object in the interactive lighting environment is a three-dimensional representation of the detected object.

19. The system of claim 11, wherein the object data is based on a position of the detected object relative to a reference point at the venue.

20. The system of claim 19, further comprising:
a sensor configured to detect the position of the detected object.
